(19) United States
(12) Patent Application Publication
(10) Pub. No.: US 2015/0204393 A1
(43) Pub. Date: Jul. 23, 2015

(54) DUAL WINDING ELECTRIC ACTUATOR FOR HYBRID SYSTEM

(71) Applicant: GM GLOBAL TECHNOLOGY OPERATIONS LLC, Detroit, MI (US)

(72) Inventor: Alan G. Holmes, Clarkston, MI (US)

(73) Assignee: GM GLOBAL TECHNOLOGY OPERATIONS LLC, Detroit, MI (US)

(21) Appl. No.: 14/159,990

(22) Filed: Jan. 21, 2014

(51) Int. Cl. F16D 27/14; F01M 1/02; F01P 3/00; B60L 11/18; B60K 1/00; B60K 6/20; B60R 16/03; B60L 11/08; B60H 1/00; F01P 1/00

(52) U.S. Cl. CPC F16D 27/14; B60H 1/00428; F01M 1/02; F01P 3/00; F01P 1/00; B60K 1/00; B60K 6/20; B60R 16/03; B60L 11/08; B60L 11/1803; F01M 2001/0215; F01P 2003/001

(57) ABSTRACT

A hybrid vehicle includes a dual winding electrical actuator for actuating an actuated mechanism. The actuator includes a low voltage winding coupled to a low voltage electrical system, and a high voltage winding coupled to a high voltage electrical system. Both the low voltage winding and the high voltage winding are operable to generate a magnetic field. The actuator includes an electromagnetic stator core that is operable to react against the magnetic field from both the low voltage winding and the high voltage winding to produce a torque. The dual winding actuator may be used as a voltage converter to convert the voltage between the high voltage electrical system and the low voltage electrical system, thereby eliminating the need for a separate voltage converter.

### TECHNICAL FIELD

The invention generally relates to an electric actuator for controlling an actuated mechanism, in a hybrid vehicle.

### BACKGROUND

Automotive vehicles typically include electrically powered accessories, such as headlamps, a stereo and/or video systems, cabin lights, etc. The electrically powered accessories are powered by a low voltage electrical system. The low voltage electrical system is often referred to as a 12 volt system, but typically operates between 8 and 16 volts. The low voltage electrical system often includes a low voltage battery, which is charged by an engine driven alternator. In a hybrid vehicle, a high voltage electrical system, including a high voltage battery and a high voltage propulsion motor/generator, may be used to provide the electrical energy to the low voltage electrical system, and thereby to the electrically powered accessories. The high voltage electrical system typically operates at a voltage that is greater than 60 volts, and is preferably between 100 and 200 volts. However, the high voltage electrical system may include a 24 volt system that operates between 16 and 32 volts. Because the high voltage propulsion motor/generator typically provides power at a different voltage than is required to operate the low voltage electrical accessories, a voltage converter, sometimes referred to as an auxiliary power module, is needed to convert the electrical power from the high voltage electrical system to the voltage required by the low voltage accessories.

### SUMMARY

A vehicle is provided. The vehicle includes a high voltage electrical system, and a low voltage electrical system. The high voltage electrical system operates at least one high voltage electrical component. The high voltage electrical system operates with a voltage greater than a first voltage. The low voltage electrical system operates at least one low voltage electrical component. The low voltage electrical system operates with a voltage less than a second voltage. The vehicle further includes an actuated mechanism, and an actuator coupled to the actuated mechanism. The actuator is configured to control the actuated mechanism. The actuator includes a low voltage winding coupled to the low voltage electrical system, and a high voltage winding coupled to the high voltage electrical system. Both the low voltage winding and the high voltage winding are operable to generate a magnetic field. An electromagnetic stator core is operable to react against the magnetic field from both the low voltage winding and the high voltage winding to produce a torque.

A powertrain for a hybrid vehicle is also provided. The powertrain includes a high voltage electrical system including a high voltage battery and a high voltage propulsion motor/generator, and a low voltage electrical system including a low voltage battery. The high voltage electrical system operates with a voltage greater than a first voltage, and the low voltage electrical system operates with a voltage less than a second voltage. The powertrain further includes an actuated mechanism, and an actuator that is coupled to the actuated mechanism for controlling the actuated mechanism. The actuator includes a low voltage winding coupled to the low voltage electrical system, and a high voltage winding that is coupled to the high voltage electrical system. Both the low voltage winding and the high voltage winding are operable to generate a magnetic field. An electromagnetic stator core is operable to react against the magnetic field from both the low voltage winding and the high voltage winding to produce a torque. The actuator is operable to convert a high voltage electrical current from the high voltage electrical system, having a voltage greater than the first voltage, to a low voltage electrical current for use by the low voltage electrical system, having a voltage less than the second voltage. The actuator is further operable to actuate the actuated mechanism from electrical power supplied from both the high voltage electrical system and the low voltage electrical system. The powertrain is characterized by the high voltage electrical system not including a voltage converter for converting electrical power from the first voltage to the second voltage for the low voltage electrical system.

Accordingly, by incorporating both the high voltage winding and the low voltage winding into the actuator of the actuated mechanism, the actuator for the actuated mechanism may be used as a voltage converter, thereby eliminating the need for a separate voltage converter, i.e., an auxiliary power module. The actuator may be used to control many different actuated mechanisms, such as but not limited to a transmission clutch, an oil pump, a water pump, an engine cooling fan, and Heating Ventilation Air Conditioning (HVAC) cabin fan, or an air conditioning compressor. The actuator may operate from electrical power from either the low voltage electrical system and/or the high voltage electrical system, to control the actuated mechanism. The actuator is not only used to actuate the actuated mechanism, but is also used to convert electrical power at the high voltage used by the high voltage electrical system to a lower voltage suitable for use by the low voltage electrical system. The actuator may also be used to convert electrical power at the low voltage used by the low voltage electrical system to a higher voltage suitable for use by the high voltage electrical system. In one preferred embodiment, in which the actuated mechanism is a clutch that is functionally disposed between an engine and the high voltage propulsion motor/generator, the clutch may be used to transfer torque from the engine to the actuator so that the actuator may be used as a generator to generate electricity for one or both of the high voltage electrical system or the low voltage electrical system.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram representing a dual winding electric actuator for an actuated mechanism, coupled to both a high voltage electrical system and a low voltage electrical system.

FIG. 2 is a schematic diagram showing a hybrid vehicle incorporating the dual winding electric actuator therein.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

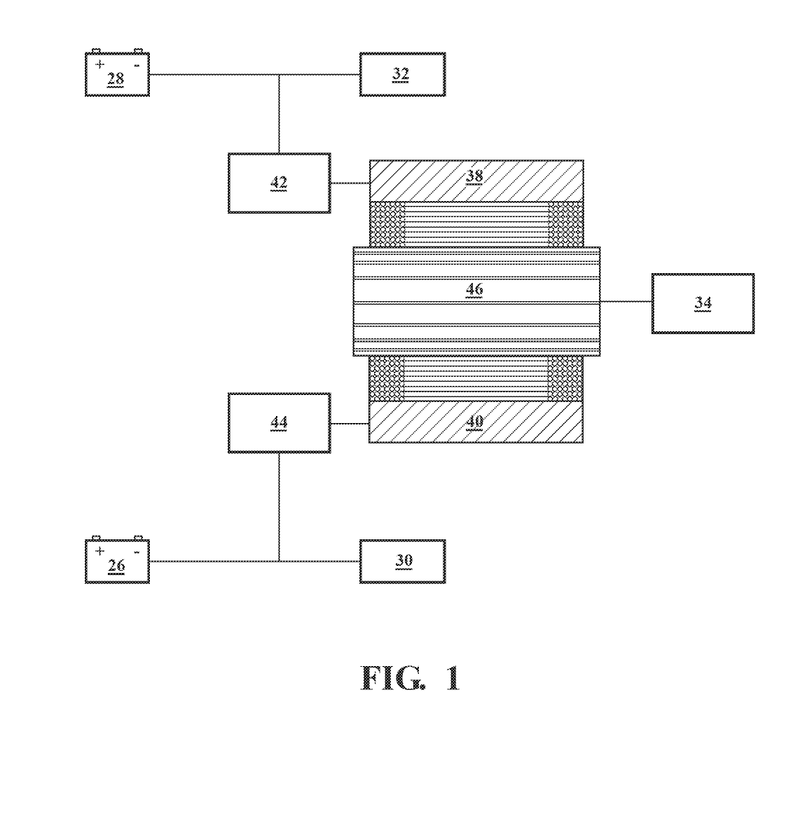

Referring to the Figures, wherein like numerals indicate like parts throughout the several views, a vehicle is generally shown at 20. The vehicle 20 is a hybrid vehicle, having both a high voltage electrical system 22, and a low voltage electrical system 24. Referring to FIG. 1, the high voltage electrical system 22 includes a high voltage battery 26, and the low voltage electrical system 24 includes a low voltage battery 28. It should be appreciated that the low voltage battery 28 is separate and distinct from the high voltage battery 26.

The high voltage electrical system 22 is used to operate at least one high voltage electrical component, such as but not limited to a high voltage propulsion motor/generator 30. The high voltage propulsion motor/generator 30 is used to provide tractive power to wheels 50 of the vehicle 20 to propel the vehicle 20. The high voltage electrical system 22 operates with a voltage greater than a first voltage. The low voltage electrical system 24 is used to operate at least one low voltage electrical component 32. The low voltage electrical component 32 may include, but is not limited to, vehicle 20 headlights, audio/video entertainment systems, cabin lights, electrical actuators 36, fans, power outlets, etc. The low voltage electrical system 24 operates with a voltage less than a second voltage. The first voltage may be equal to or greater than 16 volts, and the second voltage may be equal to or less than 16 volts. Accordingly, the high voltage electrical system 22 operates at a voltage that is greater than 16 volts, and the low voltage electrical system 24 operates at a voltage that is less than 16 volts.

The vehicle 20 further includes an actuated mechanism 34. The actuated mechanism 34 may be actuated by an applied torque. As such, the actuated mechanism 34 may be considered a rotary actuated mechanism 34, i.e., a mechanism actuated by rotational movement. The actuated mechanism 34 may include one of, but is not limited to: a transmission 54 clutch, an oil pump, a water pump, an engine 52 cooling fan, and Heating Ventilation Air Conditioning (HVAC) cabin fan, or an air conditioning compressor.

An actuator 36 is coupled to the actuated mechanism 34. The actuator 36 controls or actuates the actuated mechanism 34. The actuator 36 is not a propulsion motor, and as such, is not used to provide propulsion or tractive torque for the vehicle 20. However, the actuator 36 may be referred to as an electric motor/generator, and more specifically, the actuator 36 may include a dual winding electric motor/generator, that is operable to provide the rotational input, i.e., a torque, to actuate the actuated mechanism 34. Alternatively, the actuator 36 may include a linear actuator that generates a force directed along a linear path, to actuate the actuated mechanism 34. The actuator 36 includes a low voltage winding 38 that is coupled to the low voltage electrical system 24, and a high voltage winding 40 that is coupled to the high voltage electrical system 22. The low voltage winding 38 typically includes fewer turns of thicker wire relative to the high voltage winding 40, which includes more turns of thinner wire when compared to the low voltage winding 38. One or more low voltage switches 42 may interconnect the low voltage winding 38 with the low voltage battery 28 and the low voltage electrical component 32. One or more high voltage switches 44 may interconnect the high voltage winding 40 with the high voltage battery 26 and/or the high voltage propulsion motor/generator 30.

Both the low voltage winding 38 and the high voltage winding 40 are operable to generate a magnetic field in response to an applied electric current from the low voltage electrical system 24 and the high voltage electrical system 22 respectively. The actuator 36 further includes an electromagnetic stator core 46, which reacts against a magnetic field, from one or both of the low voltage winding 38 or the high voltage winding 40, to produce the torque that is used to actuate the actuated mechanism 34. The dual winding actuator 36 may be constructed and operates as is well known in the art. Accordingly, the actuator 36 is operable to actuate the actuated mechanism 34 from electrical power supplied from the high voltage electrical system 22 alone, the low voltage electrical system 24 alone, or from electrical power supplied simultaneously from both the high voltage electrical system 22 and the low voltage electrical system 24.

Because the actuator 36 includes both the high voltage winding 40 and the low voltage winding 38, the actuator 36 may be used as a voltage converter. As such, the actuator 36 is operable to convert a high voltage electrical current from the high voltage electrical system 22, having a voltage greater than the first voltage, to a low voltage electrical current for use by the low voltage electrical system 24, having a voltage less than the second voltage. Additionally, the actuator 36 is operable to convert a low voltage electrical current from the low voltage electrical system 24, having a voltage less than the second voltage, to a high voltage electrical current for use by the high voltage electrical system 22, having a voltage greater than the first voltage. Because the actuator 36 may be used as a voltage converter, the high voltage electrical system 22 does not need to include a separate voltage converter for converting electrical power from the first voltage to the second voltage for the low voltage electrical system 24.

The actuated mechanism 34 may be actuated by either a forward torque or a drag torque. In the case of actuation with a forward torque, the actuated mechanism 34 tends to add to the propulsion of the vehicle. In the case of actuation with a drag torque, the net electrical power to the actuator 36 may be negative. When actuated by a drag torque, the actuator 36 may be converting rotational mechanical power from the actuated mechanism 34 into electrical power either as an alternative to or in addition to the conversion of high voltage electrical power to low voltage electrical power.

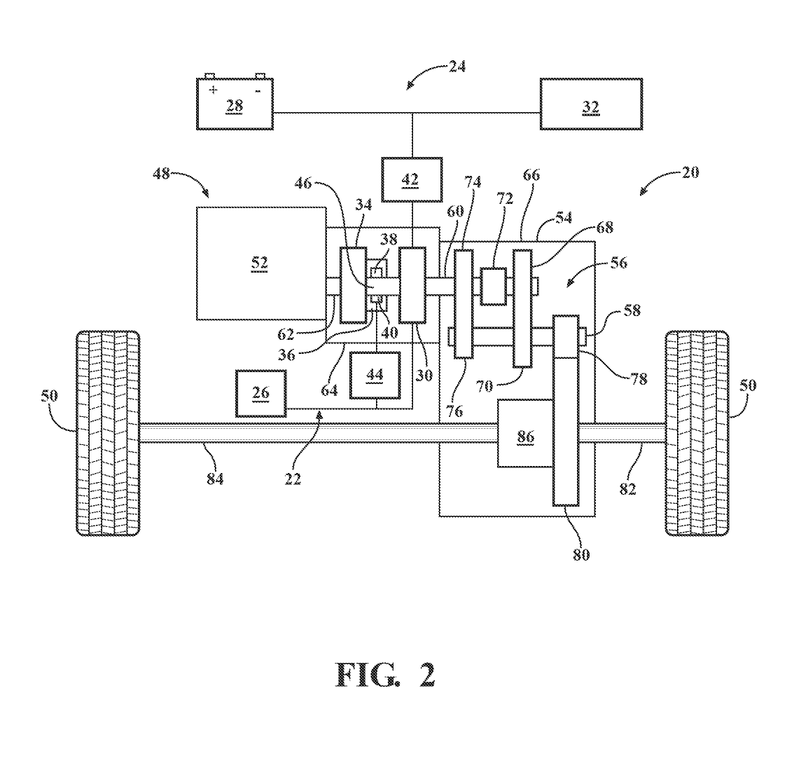

Referring to FIG. 2, an exemplary embodiment of a powertrain 48 for the hybrid vehicle 20 is shown, which incorporates the dual winding actuator 36 therein. The powertrain 48 provides tractive torque to one or more vehicle 20 wheels 50 for propelling the vehicle 20. The powertrain 48 includes a prime mover, such as but not limited to an internal combustion engine 52 that creates a rotational output, i.e., a driving torque, by combusting fuel. The powertrain 48 further includes the high voltage propulsion motor/generator 30 that uses electric power from the high voltage battery 26 to generate a driving torque. The powertrain 48 further includes a transmission 54 that can transfer torque from the engine 52 and/or the high voltage propulsion motor/generator 30 to the vehicle 20 wheels 50 through a gearing arrangement 56 at various ratios of torque of a transmission output member 58 to torque of a transmission input member 60. The different ratios are established by selective engagement of different torque transfer devices, such as clutches, brakes, or synchronizers 72. As discussed herein, the actuated mechanism 34 may include at least one of the torque transfer devices, hereinafter referred to within the embodiment of FIG. 2 as a rotating clutch 34. The rotating clutch 34 and the actuator 36 are functionally disposed between the engine 52 and the high voltage propulsion motor/generator 30. As noted above, the actuator 36 is not a propulsive device, and is not used to provide tractive torque to propel the vehicle 20. The rotating clutch 34, when engaged, transfers torque that is carried along a torque transfer path from the transmission output member 60 to the transmission output member 58. The dual winding actuator 36 actuates the rotating clutch 34 to change its state from a disengaged state to an engaged state or, in some embodiments, from an engaged state to a disengaged state.

The engine 52 has a crankshaft 62 that is operatively connected for rotation with the transmission output member 60 when the rotating clutch 34 is engaged. A stationary bell housing 64 surrounds the rotating clutch 34, the actuator 36, and the high voltage propulsion motor/generator 30. The bell housing 64 can mount to or be made integral with a transmission housing 66 that surrounds the gearing arrangement 56. The gearing arrangement 56 includes a first set of meshing gears 68, 70 that can transfer torque from the input member to the output member at a first gear ratio when a synchronizer 72 is shifted to the right to engage gear 68 with the input member, and a second set of intermeshing gears 74, 76 that can transfer torque from the input member to the output member when the synchronizer 72 is shifted to the left to engage gear 74 with the input member, as is understood by those skilled in the art. Additional sets of intermeshing gears and synchronizers 72 can be included. A final drive gear set includes intermeshing gears 78, 80 that transfer torque from the transmission output member 58 to half shafts 82, 84 via a differential 86. The half shafts 82, 84 are operatively connected to the wheels 50.

The high voltage propulsion motor/generator 30 is disposed within the bell housing 64, in torque communication with the transmission output member 60. The high voltage propulsion motor/generator 30 and the high voltage winding 40 of the actuator 36 are both coupled to the high voltage battery 26. The low voltage winding 38 of the actuator 36 is coupled to the low voltage battery 28, and at least one low voltage electrical component 32.

As described above, the actuator 36 moves in response to an electric current from one or both of the high voltage electrical system 22 and the low voltage electrical system 24 to engage and/or disengage the rotating clutch 34. Additionally, as described above, the actuator 36 is operable to convert a high voltage electrical current from the high voltage electrical system 22, having a voltage greater than the first voltage, to a low voltage electrical current for use by the low voltage electrical system 24, having a voltage less than the second voltage. Additionally, the actuator 36 is operable to convert a low voltage electrical current from the low voltage electrical system 24, having a voltage less than the second voltage, to a high voltage electrical current for use by the high voltage electrical system 22, having a voltage greater than the first voltage. Furthermore, in the embodiment shown in FIG. 2, the rotating clutch 34, i.e., the actuated mechanism 34, is operable to receive the rotational output from the engine 52. The rotating clutch 34 is engaged to transmit torque from the engine 52 to the transmission output member 60, the rotating clutch 34 rotates the electromagnetic stator core 46 of the actuator 36. Because the actuator 36 is equipped with both the low voltage winding 38 and the high voltage winding 40, the actuator 36 may convert the rotational output from the engine 52 into a low voltage electrical current for the low voltage electrical system 24, having a voltage less than the first voltage, or a high voltage electrical current for the high voltage electrical system 22, having a voltage greater than the second voltage.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A vehicle comprising:
a high voltage electrical system for operating at least one high voltage electrical component, wherein the high voltage electrical system operates with a voltage greater than a first voltage;
a low voltage electrical system for operating at least one low voltage electrical component, wherein the low voltage electrical system operates with a voltage less than a second voltage;
an actuated mechanism; and
an actuator coupled to the actuated mechanism for controlling the actuated mechanism, the actuator including:
a low voltage winding coupled to the low voltage electrical system, and operable to generate a magnetic field;
a high voltage winding coupled to the high voltage electrical system, and operable to generate a magnetic field; and
an electromagnetic stator core operable to react against the magnetic field from both the low voltage winding and the high voltage winding to produce a torque.

2. The vehicle set forth in claim 1 wherein the actuator is operable to convert a high voltage electrical current from the high voltage electrical system, having a voltage greater than the first voltage, to a low voltage electrical current for use by the low voltage electrical system, having a voltage less than the second voltage.

3. The vehicle set forth in claim 2 wherein the actuator is operable to convert a low voltage electrical current from the low voltage electrical system, having a voltage less than the second voltage, to a high voltage electrical current for use by the high voltage electrical system, having a voltage greater than the first voltage.

4. The vehicle set forth in claim 3 wherein the actuator is operable to actuate the actuated mechanism from electrical power supplied from both the high voltage electrical system and the low voltage electrical system.

5. The vehicle set forth in claim 1 wherein the low voltage electrical system includes a low voltage battery, and wherein the high voltage electrical system includes a high voltage battery.

6. The vehicle set forth in claim 5 wherein the actuated mechanism is actuated by an applied torque.

7. The vehicle set forth in claim 6 wherein the actuated mechanism includes one of: a transmission clutch, an oil pump, a water pump, an engine cooling fan, and Heating Ventilation Air Conditioning (HVAC) cabin fan, or an air conditioning compressor.

8. The vehicle set forth in claim 7 wherein the high voltage electrical system includes a high voltage propulsion motor/generator.

9. The vehicle set forth in claim 8 further comprising an engine operable to produce a rotational output.

10. The vehicle set forth in claim 9 wherein the actuated mechanism is operable to receive the rotational output from the engine, and may convert the rotational output from the engine into a low voltage electrical current for the low voltage electrical system, having a voltage less than the first voltage, or a high voltage electrical current for the high voltage electrical system, having a voltage greater than the second voltage.

11. The vehicle set forth in claim 10 wherein the actuated mechanism includes a rotating transmission clutch functionally disposed between the engine and the high voltage propulsion motor/generator.

12. The vehicle set forth in claim 1 wherein the actuator includes a dual winding electric motor/generator, operable to produce a torque for actuating the actuated mechanism.

13. The vehicle set forth in claim 1 wherein the first voltage is equal to or greater than 16 volts, and the second voltage is equal to or less than 16 volts.

14. The vehicle set forth in claim 1 characterized by the high voltage electrical system not including a voltage converter for converting electrical power from the first voltage to the second voltage for the low voltage electrical system.

15. A powertrain for a hybrid vehicle, the powertrain comprising:
a high voltage electrical system including a high voltage battery and a high voltage propulsion motor/generator, wherein the high voltage electrical system operates with a voltage greater than a first voltage;
a low voltage electrical system including a low voltage battery, wherein the low voltage electrical system operates with a voltage less than a second voltage;
an actuated mechanism that is actuated by an applied torque; and
an actuator coupled to the actuated mechanism for controlling the actuated mechanism, the actuator including:
a low voltage winding coupled to the low voltage electrical system, and operable to generate a magnetic field;
a high voltage winding coupled to the high voltage electrical system, and operable to generate a magnetic field; and
an electromagnetic stator core operable to react against the magnetic field from both the low voltage winding and the high voltage winding to produce a torque;
wherein the actuator is operable to convert a high voltage electrical current from the high voltage electrical system, having a voltage greater than the first voltage, to a low voltage electrical current for use by the low voltage electrical system, having a voltage less than the second voltage;
wherein the actuator is operable to convert a low voltage electrical current from the low voltage electrical system, having a voltage less than the second voltage, to a high voltage electrical current for use by the high voltage electrical system, having a voltage greater than the first voltage; and
wherein the actuator is operable to actuate the actuated mechanism from electrical power supplied from both the high voltage electrical system and the low voltage electrical system; and
wherein the high voltage electrical system does not include a voltage converter for converting electrical power from the first voltage to the second voltage for the low voltage electrical system.

16. The powertrain set forth in claim 15 wherein the actuated mechanism includes one of: a transmission clutch, an oil pump, a water pump, an engine cooling fan, and Heating Ventilation Air Conditioning (HVAC) cabin fan, or an air conditioning compressor.

17. The powertrain set forth in claim 15 further comprising an engine operable to produce a rotational output.

18. The powertrain set forth in claim 17 wherein the actuated mechanism is operable to receive the rotational output from the engine, and may convert the rotational output from the engine into a low voltage electrical current for the low voltage electrical system, having a voltage equal to or less than the first voltage, or a high voltage electrical current for the high voltage electrical system, having a voltage equal to or greater than the second voltage.

19. The powertrain set forth in claim 15 wherein the actuated mechanism includes a rotating transmission clutch functionally disposed between the engine and the high voltage propulsion motor/generator, and wherein the actuated mechanism may be actuated by either a forward torque or a drag torque.

20. The powertrain set forth in claim 15 wherein the first voltage is equal to or greater than 16 volts, and the second voltage is equal to or less than 16 volts.
